(19) United States
(12) Patent Application Publication
(10) Pub. No.: US 2016/0289071 A1
(43) Pub. Date: Oct. 6, 2016

(54) E-HYBRID REFORMING

(71) Applicants: Rachid Mabrouk, Munchen (DE); Wolfgang Vogel, Gauting (DE); Volkmar Lemme, Munchen (DE); Andreas Seliger, Munchen (DE)

(72) Inventors: Rachid Mabrouk, Munchen (DE); Wolfgang Vogel, Gauting (DE); Volkmar Lemme, Munchen (DE); Andreas Seliger, Munchen (DE)

(21) Appl. No.: 15/060,662

(22) Filed: Mar. 4, 2016

(30) Foreign Application Priority Data
Mar. 31, 2015 (DE) DE 102015004122.3

(51) Int. Cl. C01B 3/34; B01J 19/24

(52) U.S. Cl. CPC C01B 3/34; B01J 19/2415; B01J 19/242; C01B 2203/0216; C01B 2203/0811; C01B 2203/085; B01J 2219/00157; B01J 2219/00132; B01J 2219/24

(57) ABSTRACT

A process for producing synthesis gas, by providing a feed gas stream, the feed gas stream including a hydrocarbon, preferably methane, and steam; heating of at least one part of the feed gas stream in a first steam reformer using heat of combustion; and converting of the heated feed gas stream into a synthesis gas stream of CO and H2 in a reforming step. At least one part of the feed gas stream is heated outside the first steam reformer, at least partly using electric energy.

The invention relates to a process and a plant for producing synthesis gas.

A process of this type comprises the steps of provision of a feed gas stream, where the feed gas stream comprises at least one hydrocarbon, preferably methane, steam and optionally a hydrocarbon having at least two carbon atoms, heating of at least one part of the feed gas stream in a first steam reformer using heat of combustion and conversion of the heated feed gas stream into a synthesis gas stream comprising CO and H2 in a reforming step.

The first steam reformer here comprises at least one first reformer tube and a combustion chamber, where said at least one part of the feed gas stream is heated in the reformer tube and optionally conveyed through the combustion chamber of the first steam reformer and preheated there before introduction into the reformer tube.

In processes for producing synthesis gas, for instance in autothermal reforming (ATR), partial oxidation (POX) or steam methane reforming (SMR), hydrocarbon streams and process streams are preheated, for example by means of hot process or product streams or in combustion chambers, before they are transferred into the reforming reactor.

In the case of steam methane reforming, heat of reaction is required for the endothermic synthesis gas reaction and this is typically provided by oxidation of a fuel stream in the combustion chamber of a steam reformer. The fuel stream is usually natural gas or combustible tailgases from synthesis gas production or subsequent process steps. The combustion chamber surrounds the reformer tubes in which the reaction to form synthesis gas is carried out. In the other, abovementioned processes (ATR, POX), the heat of reaction required is provided in situ by partial oxidation.

A disadvantage here is that, firstly, fuels have to be consumed by the abovementioned provision of the heat of reaction and, secondly, the carbon dioxide emission from synthesis gas production is increased thereby.

In view of this background, it is therefore an object of the present invention to provide a technically simple and economical process for producing synthesis gas, which can, in particular, be integrated in a simple way into existing processes and plants.

This object is achieved by at least one part of the feed gas stream being heated outside the first steam reformer, at least partly using electric energy.

The proposed invention offers a number of advantages. The use of the electric heating power enables the fuel consumption and the carbon dioxide emission of synthesis gas production to be reduced. Furthermore, the heat efficiency of the process is increased by the use of electric heating power. In particular, the proposed invention makes it possible to make use of overcapacities in power supply economically and ecologically sensibly. The process of the invention can be operated flexibly, so that the electric heating power supplied can be adapted to current power prices in order to operate the process as economically as possible. Furthermore, the process of the invention can be integrated into existing plants which have to be retrofitted only minimally for this purpose.

In some embodiments of the invention, the at least one part of the feed gas stream is heated inductively. For the purposes of the invention, inductive healing is an operation hi which an electrically conductive body is heated or warmed by means of eddy current losses generated therein. The electrically conductive body to be heated is preferably configured as a tube which conveys the at least one part of the feed gas stream, so that this part is likewise heated in the interior of the electrically conductive body. Such an eddy current is typically induced in the electrically conductive body by a coil which is arranged around the body and through which a (for example low- or medium-frequency) alternating current flows. A thermally insulating sheath is advantageously arranged around the electrically conductive body to be heated.

In some embodiments of the invention, the heat of combustion is provided by combustion of a fuel using an oxygen-containing gas stream or in the presence of oxygen. The fuel can advantageously be provided by the feed gas stream itself or by tailgases which can occur in the further work-up or further processing of the synthesis gas.

In some embodiments of the invention, the proportion of the feed gas stream which is heated by means of electric energy outside the first steam reformer is in the range from 0% by volume to 80% by volume of the feed gas stream, with the part of the feed gas stream preferably being able, to be heated inductively to a temperature in the range from 300° C. to 650° C. In some embodiments of the invention, the proportion of the feed gas stream which is heated by means of electric energy is in the range from 10% by volume to 80% by volume, from 20% by volume to 70% by volume, from 30% by volume to 60% by volume or from 40% by volume to 50% by volume, of the feed gas stream. For this purpose, this part of the feed gas stream is preferably conveyed through a pipe into an electric heating device in which the part is then heated.

In some embodiments of the invention, the remaining part of the feed gas stream is conveyed through the combustion chamber of the steam reformer and subsequently into die first reformer tube and heated as a result. The remaining part is advantageously conveyed through a pipe through the combustion chamber of the first steam reformer. The passage of the remaining part of the feed gas stream through the pipe advantageously protects the pipe against excessive heating.

In some embodiments of the invention, the part of the teed gas stream which has been heated by means of the electric heating device is subsequently heated further to a temperature in the range from 750° C. to 950° C. In the steam reformer using heat of combustion. This part of the feed gas stream is preferably heated in the at least one first reformer tube of the first steam reformer, with the at least one first reformer tube being surrounded by a combustion chamber in which the abovementioned fuel is burnt to produce heat and the heat produced being transferred to the at least one first reformer tube and thus also to the feed gas stream.

In some alternative embodiments of the invention, the feed gas stream is divided into a first feed gas substream and a second feed gas substream. Here, the first feed gas substream is heated in the first steam reformer using heat of combustion, preferably to a temperature in the range from 750° C. to 950° C., and converted into a first synthesis gas stream, and the second feed gas substream is heated using electric energy, preferably to a temperature in the range from 750° C. to 950° C., and converted in a second steam reformer into a second synthesis gas stream.

In some embodiments of the invention, the first feed gas substream is conveyed through a pipe through the combustion chamber of the first steam reformer, as a result of which the first feed gas substream is heated, and subsequently into the at least one first reformer tube in which the first feed gas substream is heated further.

In some embodiments of the invention, the second feed gas substream is heated in at least one second reformer tube, with the at least one second reformer tube being encompassed by the second steam reformer and being heated, preferably inductively, using electric energy.

In some embodiments of the invention, the first synthesis gas stream and the second synthesis gas stream are combined into one synthesis gas stream.

Some alternative embodiments of the invention provided for one part of the feed gas stream to be heated outside the first steam reformer using electric energy, preferably to a temperature in the range from 450° C. to 500° C., and reacted to give a prereformed teed gas substream, with part of the hydrocarbons being converted into synthesis gas. The prereformed feed gas substream is subsequently conveyed into the at least one first reformer tube of the first steam reformer, heated further there and converted completely into synthesis gas. As an alternative, the total feed gas stream is, as described above, heated and prereformed.

In a further aspect of the invention, a plant for producing synthesis gas is provided. The plant comprises:
at least one pipe which is configured for conveying a feed gas stream,
a first steam reformer which has a combustion chamber, a burner and at least one first reformer tube which is connected fluidically to the at least one pipe and is at least partly arranged in the combustion chamber,
where the burner is configured for burning a gas stream comprising a fuel in the presence of oxygen with production of heat in the combustion chamber, so that the heat produced can be transferred to the first reformer tube, and
an electric heating device which is arranged outside the first steam reformer and is configured for heating at least one part of the feed gas stream.

The plant of the invention is particularly suitable for carrying out the process of the invention for producing synthesis gas.

An advantage of the plant of the invention is that such a plant can be operated both in conventional operation, i.e. by provision of the necessary heat of reaction by means of combustion when no electric power is available or electric power is only available at high prices, and also in hybrid operation when electric power is available at favorable prices. The fuel consumption and carbon dioxide emission of the plant advantageously decrease in hybrid operation. Existing conventional plants can also be retrofitted very simply.

In one embodiment of the invention, the at least one pipe is configured for conveying the feed gas stream through the combustion chamber before introduction into the at least one first reformer tube.

In some embodiments of the invention, the electric heating device is arranged upstream of the at least one first reformer tube so that the at least one part of the feed gas stream can be heated firstly by the heating device and then by the burner.

In some alternative embodiments of the invention, the electric heating device is arranged within a second steam reformer, with the second steam reformer having at least one second reformer tube and the at least one second reformer tube being fluidically connected to the at least one pipe, so that it can convey the at least one part of the feed gas stream into the at least one second reformer tube.

In some embodiments of the invention, the electric heating device is arranged within a prereformer, with the prereformer comprising at least one prereformer tube, the prereformer being arranged upstream of the at least one first reformer tube of the first steam reformer and the at least one prereformer tube being fluidically connected to the at least one pipe, so that it can convey the at least one part of the feed gas stream into the at least one prereformer tube.

In some embodiments of the invention, the electric heating device is configured for heating the at least one pipe, the at least one second reformer tube or the at least one prereformer tube, where the heating device preferably has a current-conducting coil which is configured for inducing an eddy current in the at least one pipe, in the at least one second reformer tube or in the at least one prereformer tube when current flows through the coil.

Further details and advantages of the invention will be explained by the following descriptions of working examples with the aid of the figures.

The figures show:

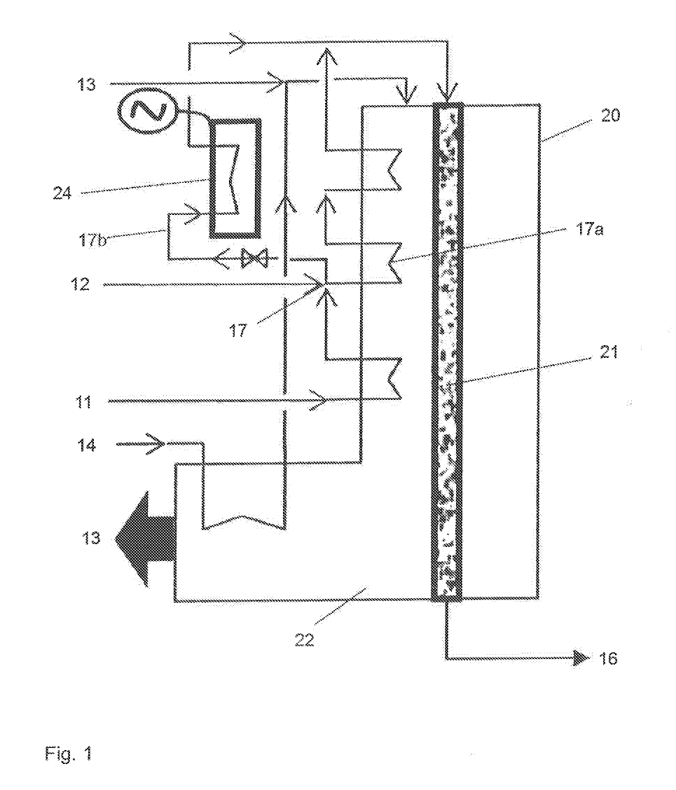

FIG. 1 a scheme of an embodiment of the invention;

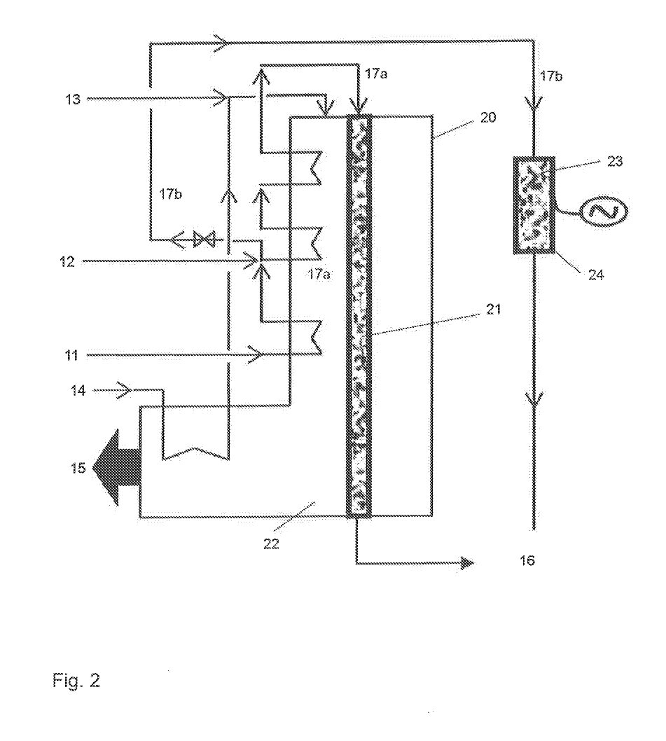

FIG. 2 a scheme of an alternative embodiment of the invention; and

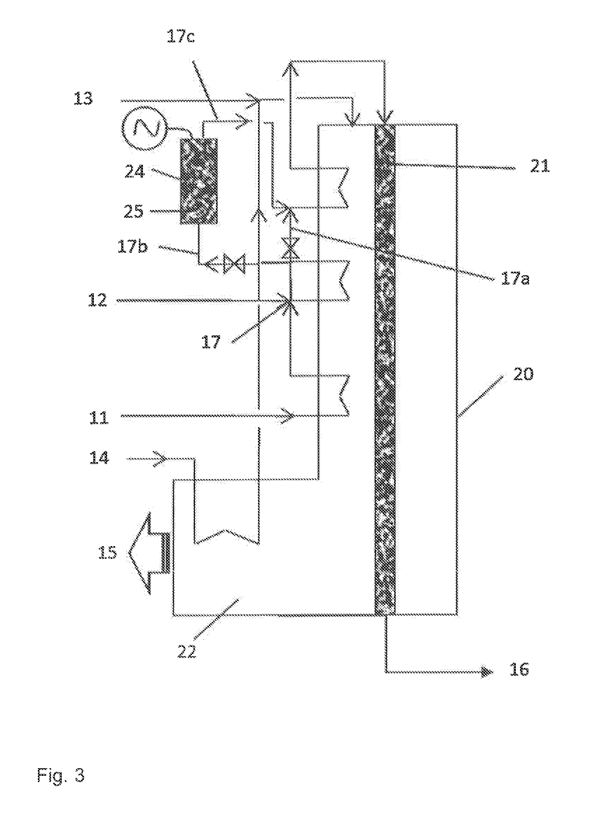

FIG. 3 a scheme of a further alternative embodiment of the invention.

### EXAMPLES

### Example 1

FIG. 1 illustrates a preferred plant configuration and way of carrying out the process according to the invention. A hydrocarbon-containing gas stream 11, for example natural gas or biogas, is mixed with steam 12 and the resulting feed gas stream 17 is fed via a pipe into a steam reformer 20 and reacted there to form a synthesis gas stream 16 comprising CO and H2. The steam reformer 20 comprises at least one reformer tube 21, a combustion chamber 22 and a burner. The reformer tube 21 is equipped with a suitable catalyst, for instance a nickel or ruthenium catalyst, and configured for converting the abovementioned feed gas stream 17 into synthesis gas. The heat required for this purpose is partly provided by combustion of a fuel 13 by means of air 14 or oxygen 14 in the combustion chamber 22 of the steam reformer 20. The reformer tube 21 is arranged relative to the combustion chamber 22 in such a way that the heat produced during combustion can be transferred by heat radiation or heat convection to the reformer tube 21, as a result of which the reformer tube 21 and the streams 17 conveyed therein are heated. At least one part 17a of the feed gas stream is firstly conveyed through the combustion chamber 22 of the first steam reformer 20, heated there and subsequently fed into the first reformer tube and heated further there.

According to the invention, another part 17b of the feed gas stream is firstly heated by an electric heating device 24, with the electric heating device 24 being arranged outside the first steam reformer 20, and subsequently fed into the first reformer tube 21. This part 17b of the feed gas stream preferably amounts to from 0% by volume to 80% by volume, preferably from 10% by volume to 80% by volume, of the feed gas stream 17. In particular, the part 17b of the feed gas stream 17 is heated to a temperature of from 300° C. to 650° C., and subsequently in the reformer tube 21 to a temperature of from 750° C. to 950° C. The feed gas substream 17b is heated by induction heat. The two parts 17a, 17b are advantageously combined with one another after heating in the electric heating device 24 or in the combustion chamber 22 before they are fed into the first reformer tube 21 and heated further there.

The electric heating device 24 advantageously has a current-conducting coil which is wound around part of the pipe. When a low- or medium-frequency alternating current flows through the coil, the alternating magnetic field which arises induces eddy currents in said pipe section. Here, the heat is produced in the pipe section itself and does not have to be introduced by heat conduction.

In addition, the pipe can be configured so that the feed gas stream 17 can be fed both through the electric heating device 24 and also parallel thereto through the combustion chamber 22, and subsequently into the at least first reformer tube 21.

The invention offers a number of economic and ecological advantages:
increased plant flexibility resulting from the ability to operate the synthesis gas plant using electric heat generation and using combustion heat;
reduction of the operating costs by means of a reduction in the natural gas consumption;
additional income by taking up overcapacities available on the power market;
reduction of the CO2 emission: for example in the case of a 50 kNm3/h hydrogen plant in which the equivalent of 25 MW of natural gas is at times (30% of the time) replaced by electric power, the reduction in the CO2 emission is estimated to be 50 t per day.

### Example 2

FIG. 2 shows an alternative plant configuration and way of carrying out the process according to the invention. Here, the abovementioned feed gas stream 17 is divided into a first feed gas substream 17a and a second feed gas substream 17b. The first feed gas substream 17a is fed into the first steam reformer 20, heated there under the action of the combustion heat which is generated in the combustion chamber 22 of the first steam reformer 20 and converted into a hot synthesis gas stream. The first feed gas substream 17a can advantageously be conveyed through the combustion chamber 22 and thus preheated before introduction into the first reformer tube 21.

The second feed gas substream 17b is fed into a second steam reformer which comprises at least a second reformer tube 23. The second reformer tube 23 is likewise advantageously equipped with a suitable catalyst for instance a nickel or ruthenium catalyst. According to the invention, the second steam reformer is heated by means of an electric heating device 24. In this case too, the electric heating device advantageously has a current-conducting coil which is wound around the second reformer tube 23. The heat is thus, as described in example 1, produced directly in the reformer tube 23.

### Example 3

FIG. 3 shows a further alternative plans, configuration and way of carrying out the process according to the invention. Here, a feed gas stream 17 which comprises at least one Cl-hydrocarbon and at least one hydrocarbon having two or more carbon atoms and also steam is conveyed by means of a pipe through the combustion chamber 22 of the first steam reformer 20 and heated there to a temperature in the range from 380° C. to 450° C. The heated feed gas stream 17 is subsequently divided into a first feed gas substream 17a and a second feed gas substream 17b. The second feed gas substream 17b is fed into a prereformer which has at least one prereformer tube 25 and is heated there by means of an electric heating device 24 to a temperature of from 450° C. to 500° C. and pre re formed, with the hydrocarbon having two or more carbon atoms and part of the Cl-hydrocarbon being converted into synthesis gas. This now prereformed feed gas substream 17c is then subsequently fed into the first steam reformer and converted completely into synthesis gas 16 in the first reformer tube 21. As an alternative, the entire heated feed gas stream 17 can also firstly be conveyed through the prereformer and subsequently fed into the first steam reformer 20 or the first reformer tube 21.

In this case too, the electric heating device 24 advantageously has a current-conducting coil which is wound around the prereformer tube 25. Here the heat is, as described in example 1, produced directly in the prereformer tube 25.

In this alternative form of the invention, too, fuel for providing heat of reaction for prereforming is advantageously saved. In addition, it is possible to feed the prereformed feed gas substream 17c or the entire prereformed feed gas stream into the first reformer tube 21 at higher temperatures, in particular from 600° C. to 650° C., without carbonization of the catalyst in the first reformer tube 21 having to be feared.

### LIST OF REFERENCE SIGNS

| | |
|---|---|
| 11 | natural gas |
| 12 | steam |
| 13 | fuel |
| 14 | air/oxygen |
| 15 | exhaust gas |
| 16 | hot synthesis gas |
| 17 | feed gas stream comprising natural gas and steam |
| 17a | first feed gas substream comprising natural gas and steam |
| 17b | second feed gas substream comprising natural gas and steam |
| 17c | prereformed feed gas substream |
| 20 | steam reformer |
| 21 | reformer tube |
| 22 | combustion chamber |
| 23 | reformer tube |
| 24 | electric heating device |
| 25 | prereformer tube |

1. Process for producing synthesis gas, which comprises the steps:
provision of a feed gas stream, where the feed gas stream comprises at least one hydrocarbon and steam,
heating of at least one part of the feed gas stream in a first steam reformer using heat of combustion, and
conversion of the heated feed gas stream into a synthesis gas stream comprising CO and H2 in a reforming step,
characterized in
that at least one part of the feed gas stream is heated outside the first steam reformer, at least partly using electric energy.

2. Process according to claim 1, characterized in that the at least one part of the feed gas stream is heated inductively.

3. Process according to claim 1, characterized in that the heat of combustion is provided by combustion of a fuel in the presence of oxygen.

4. Process according to claim 1, characterized in that the at least one part of the feed gas stream which is heated by means of electric energy outside the first steam reformer amounts to from 0 to 80% by volume or from 10 to 80% by volume or from 20 to 70% by volume or from 30 to 60% by volume or from 40 to 50% by volume of the feed gas stream, with the at least one part of the feed gas stream being heated to a temperature in the range from 300° C. to 650° C.

5. Process according to claim 4, characterized in that the heated at least one part of the feed gas stream is subsequently heated further to a temperature in the range from 750° C. to 950° C. in the first steam reformer using heat of combustion.

6. Process according to claim 1, characterized in that the feed gas stream is divided into a first feed gas substream and a second feed gas substream, where:
the first feed gas substream is heated to a temperature in the range from 750° to 950° in the first steam reformer using heat of combustion and converted into a first synthesis gas stream, and
the second feed gas substream is heated to a temperature in the range from 750° C. to 950° C. using electric energy and converted into a second synthesis gas stream in a second steam reformer.

7. Process according to claim 6, characterized in that the first synthesis gas stream and the second synthesis gas stream are combined to form one synthesis gas stream.

8. Process according to claim 1, characterized in that the at least one part of the feed gas stream which is heated outside the first steam reformer using electric energy to a temperature of from 450° C. to 500° C. is converted into a prereformed, synthesis gas-containing feed gas substream and the prereformed feed gas stream is subsequently fed into at least one first reformer tube in the first steam reformer, heated further there and converted completely into synthesis gas.

9. Plant for producing synthesis gas, which comprises
at least one pipe which is configured for conveying a feed gas stream,
a first steam reformer which has a combustion chamber, a burner and at least one first reformer tube which is connected fluidically to the at least one pipe and is at least partly arranged in the combustion chamber,
where the burner is configured for burning a gas stream comprising a fuel in the presence of oxygen with production of heat in the combustion chamber, so that the heat produced can be transferred to the first reformer tube,
characterized by
an electric heating device which is arranged outside the first steam reformer and is configured for heating at least one part of the feed gas stream.

10. Plant according to claim 9, characterized in that the electric heating device is arranged upstream of the at least one first reformer tube, so that the at least one part of the feed gas stream can be heated firstly by the heating device and then by the burner.

11. Plant according to claim 9, characterized in that the electric heating device is arranged within a second steam reformer, with the second steam reformer having at least one second reformer tube and the at least one second reformer tube being fluidically connected to the at least one pipe, which is configured for conveying at least one part of the feed gas stream into the second reformer tube.

12. Plant according to claim 9, characterized in that the electric heating device is arranged within a prereformer and the prereformer comprising at least one prereformer tube is arranged upstream of the at least one first reformer tube of the first steam reformer.

13. Plant according to claim 9, characterized in that the electric heating device is configured for heating the at least one pipe, the at least one second reformer tube or the at least one prereformer tube, where the heating device has a current-conducting coil which is configured for inducing an eddy current in the at least one pipe, in the at least one second reformer tube or in the at least one prereformer tube when current flows through the coil.
